(19) United States
(12) Patent Application Publication
(10) Pub. No.: US 2007/0146355 A1
(43) Pub. Date: Jun. 28, 2007

(54) Driver and display device including the same

(75) Inventor: Hyeon-seok Bae, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/644,774

(22) Filed: Dec. 21, 2006

(30) Foreign Application Priority Data
Dec. 22, 2005 (KR) 10-2005-0128033

(51) Int. Cl. G09G 5/00

(52) U.S. Cl. 345/204

(57) ABSTRACT

Provided are a driver that corrects a distorted image signal and a display device including the driver. The driver includes a control voltage signal generator which converts the voltage level of a control voltage signal according to an external signal, a clock signal generator which generates a clock signal whose duty ratio changes according to the voltage level of the control voltage signal, and a DC-DC converter which converts the level of an input voltage according to the duty ratio of the clock signal supplied from the clock signal generator and outputs the input voltage whose level is converted as a driving voltage.

### REFERENCE TO RELATED APPLICATION

This application claims priority from Korean Patent Application No. 10-2005-0128033 filed on Dec. 22, 2005 in the Korean Intellectual Property Office, the disclosure of which is incorporated herein by reference.

### BACKGROUND OF THE INVENTION

1. Field of the Invention

The present invention relates to a driver and a display device including the same, and more particularly, to a driver which corrects a distorted image signal and a display device including the driver.

2. Description of the Related Art

A liquid crystal display (LCD) generally includes a first panel having pixel electrodes, a second panel having a common electrode, a liquid crystal (LC) layer having dielectric anisotropy interposed between the first and second panels, a gate driving unit that drives a plurality of gate lines, a data driving unit that outputs a data signal, a driver that generates and outputs a gray voltage, a gate driving voltage, and a common electrode voltage.

The data driving unit receives a data signal, selects a gray voltage having an analog form corresponding to the received data signal, and applies the selected gray voltage to a pixel electrode. The liquid crystal molecules are oriented according to the potential difference between the pixel electrode to which the gray voltage is applied and the common electrode, and thus an image is displayed.

The gray voltage generator divides a driving voltage AVDD to generate multi-level gray voltages. If the driving voltage AVDD is not constant, the levels of the gray voltages change, resulting in a distortion of an image signal. It would be advantageous to be able to control the driving voltage AVDD so as to prevent distortion of the image signal.

### SUMMARY OF THE INVENTION

In accordance with the present invention a driver for a display device includes a control voltage signal generator whose output changes the duty ratio of a clock signal, a DC-DC converter which changes the level of an input voltage according to the duty ratio of the clock signal and which provides an output driving voltage and a gray voltage generator which converts the level of the driving voltage and generates a gray voltage.

### BRIEF DESCRIPTION OF THE DRAWINGS

The above and other features and advantages of the present invention will become more apparent from a reading of the ensuing description together with the drawing in which:

FIG. 1 is a block diagram of a display device of the present invention;

FIG. 2 is an equivalent circuit diagram of a pixel of a liquid crystal display (LCD) of the present invention;

FIG. 3 is a block diagram of a driver of the present invention;

FIG. 4 is a circuit diagram of a digital-to-analog (D/A) converter of FIG. 3;

FIG. 5 is a block diagram of a clock generator of FIG. 3,

FIG. 6 is a circuit diagram of a DC-DC converter of FIG. 3;

FIG. 7 is a block diagram of a driver according to another embodiment of the present invention; and

FIG. 8 is a circuit diagram of a counter of FIG. 7.

### DETAILED DESCRIPTION OF THE INVENTION

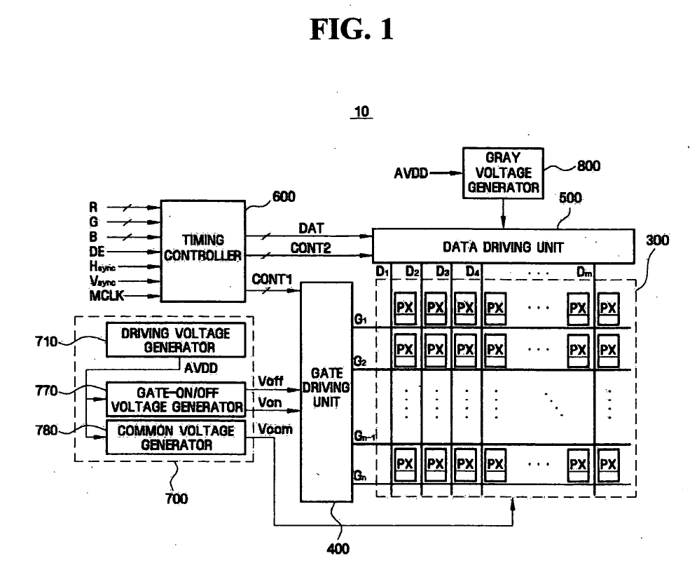

Referring to FIG. 1, the LCD includes a liquid crystal panel assembly 300, a gate driving unit 400 and a data driving unit 500 that are connected to the LC panel assembly 300, a gray voltage generator 800 connected to data driving unit 500, and a timing controller 600 and a driver 700 for controlling the LC panel assembly 300, gate driving unit 400, data driving unit 500, and gray voltage generator 800.

The equivalent circuit of the LC panel assembly 300 includes a plurality of display signal lines G1-Gn and D1-Dm and a plurality of pixels PX connected thereto and arranged in a matrix form. The LC panel assembly 300 includes a first panel 100 and a second panel 200 that face each other, and a LC layer 150 disposed between them.

The display signal lines G1-Gn and D1-Dm include a plurality of gate lines G1-Gn transmitting gate signals and a plurality of data lines D1-Dm transmitting data signals. Gate lines G1-Gn extending in a row direction are substantially parallel with one another and data lines D1-Dm extending in a column direction are substantially parallel with one another.

For a color display, each pixel uniquely represents one of three primary colors such as red, green and blue (R, G and B) colors (spatial division) or sequentially represents the three primary colors in time (temporal division), thereby obtaining a desired color.

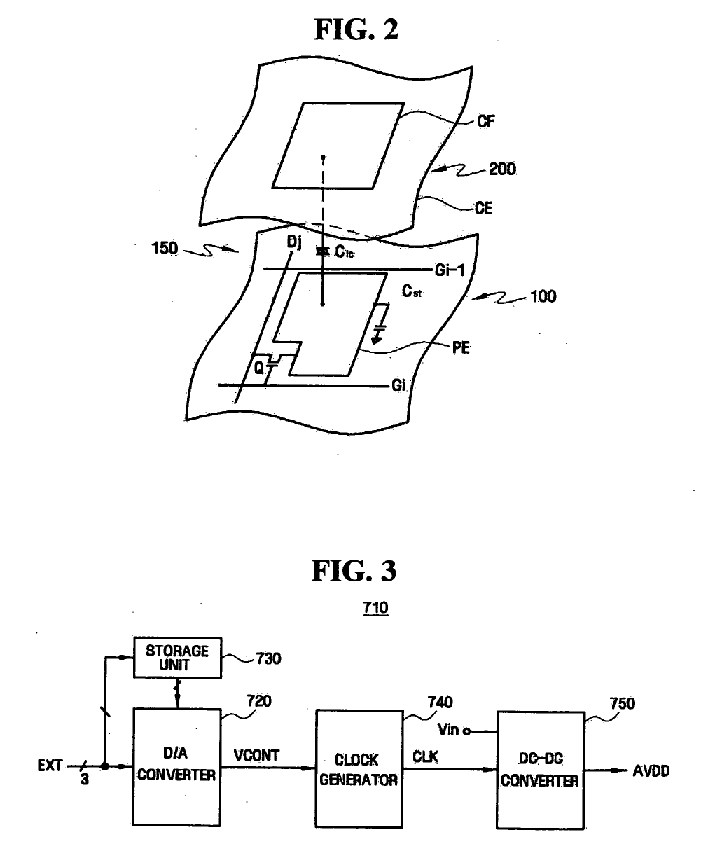

FIG. 2 is an equivalent circuit diagram of a spatial division LCD pixel. A color filter CF may be formed in a portion of a common electrode CE of the second panel 200 in such a way as to be opposite to and facing a pixel electrode PE of the first panel 100. Each pixel, e.g., a pixel connected to an i^{th} (i=1, 2, . . . , n) gate line Gi and a j^{th} (j=1, 2, . . . , m) data line Dj, includes a first switching element Q connected to gate line Gi and data line Dj, an LCD capacitor Clc and a storage capacitor Cst. Storage capacitor Cst may be omitted if desired.

Meanwhile, gate driving unit 400 of FIG. 1 is connected to gate lines G1-Gn to provide a gate signal comprised of a gate-on voltage Von and a gate-off voltage Voff generated by a gate-on/off voltage generator 770 to gate lines G1-Gn.

Gate driving unit 400 applies gate-on voltage Von generated by gate-on/off voltage generator 770 to gate lines G1-Gn in response to a gate control signal CONT1 to turn on the first switching element Q of FIG. 2 connected to each of gate lines G1-Gn. Then, the data signal applied to data lines D1-Dm is supplied to the corresponding pixels via the turned-on switching elements Q.

The difference between the data voltage and a common voltage Vcom applied to a pixel is used to charge the LC capacitor Clc to serve as a pixel voltage. The LC molecules have orientations depending on the magnitude of the pixel voltage and the orientations determine the polarization of light passing through the LC layer 150. The LC molecules are controlled based on this principle to display an image.

Data driving unit 500 is connected to data lines D1-Dm of the LC panel assembly 300 to select a gray voltage corresponding to data generated by gray voltage generator 800 and apply the selected gray voltage to a pixel as a data voltage. Here, if gray voltage generator 800 provides only a reference gray voltage instead of voltages corresponding to all gray scales, data driving unit 500 divides the reference gray voltage to generate gray voltages corresponding to all gray scales and selects one of the gray voltages.

Gate driving unit 400 or data driving unit 500 may be mounted directly on the LC panel assembly 300 in the form of a plurality of driving integrated circuit (IC) chips or may be attached to the LC panel assembly 300 in the form of a tape carrier package (TCP) after being mounted on a flexible printed circuit film. Gate driving unit 400 or data driving unit 500 may also be integrated into the LC panel assembly 300, together with the display signal lines G1-Gn and D1-Dm and the first switching element Q.

Timing controller 600 receives input image signals R, G, and B and an input control signal for controlling display of the input image signals from an external graphic controller (not shown). Examples of the input control signal include a vertical sync signal Vsync, a horizontal sync signal Hsync, a main clock signal MCLK, and a data enable signal DE.

Timing controller 600 generates a gate control signal CONT1 and a data control signal CONT2 based on the input image signals R, G, and B and the input control signal and provides gate control signal CONT1 to gate driving unit 400 and data control signal CONT2 and an image signal DAT to data driving unit 500.

Driver 700 of FIG. 1 includes a driving voltage generator 710, a gate-on/off voltage generator 770, and a common voltage generator 780. Driving voltage generator 710 generates the driving voltage AVDD that serves as a reference gray voltage for generating multi-level gray voltages and provides the generated driving voltage AVDD to gray voltage generator 800, gate-on/off voltage generator 770, and the common voltage generator 780. Driving voltage generator 710 will be described with reference to FIGS. 3 through 6.

Gray voltage generator 800 is provided with the driving voltage AVDD from the driving voltage generator 710 and generates gray voltages. Although not shown in figures, gray voltage generator 800 may include a plurality of resistors connected in series between a node to which the driving voltage AVDD is applied and ground that divide the level of the driving voltage AVDD to generate gray voltages. The internal circuitry of gray voltage generator 800 may be implemented in various ways, without being limited to the foregoing description.

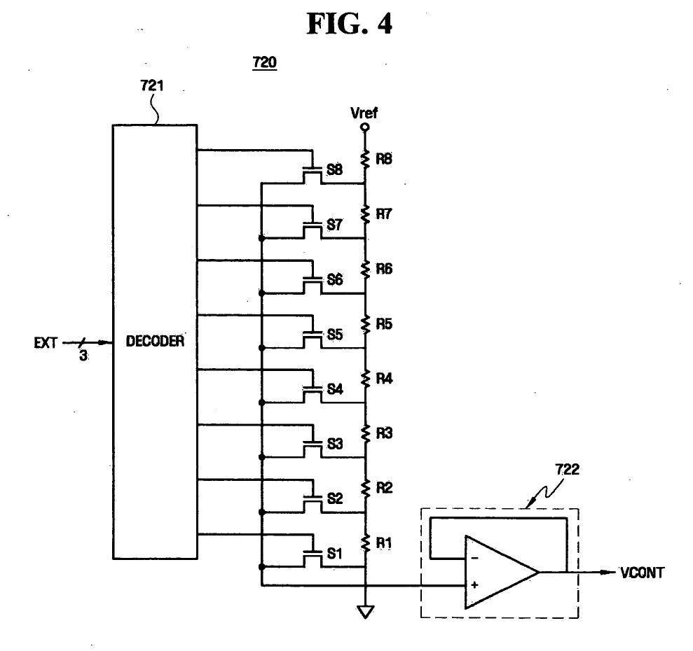

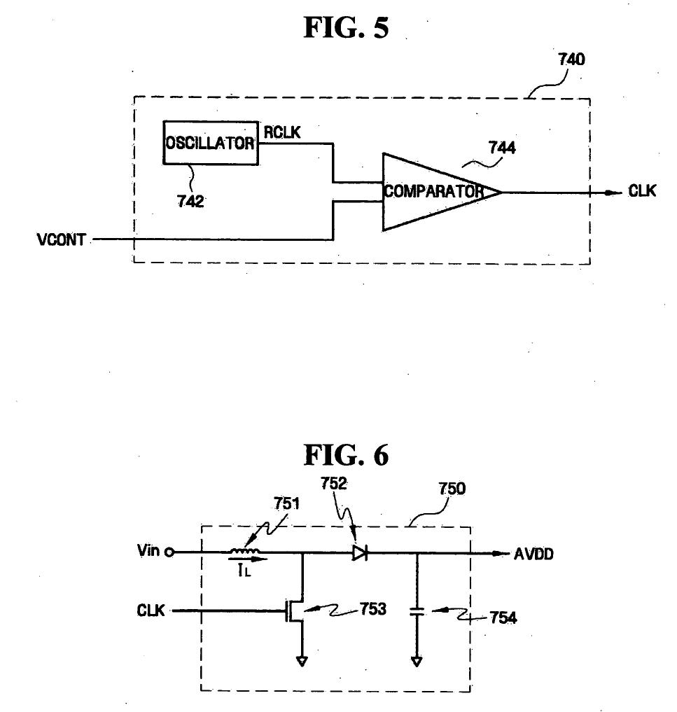

Hereinafter, driving voltage generator 710 of driver 700 of the present invention will be described with reference to FIGS. 3 through 6. FIG. 3 is a block diagram of a driver of the present invention, FIG. 4 is a circuit diagram of a digital-to-analog (D/A) converter of FIG. 3, FIG. 5 is a block diagram of a clock generator of FIG. 3, and FIG. 6 is a circuit diagram of a DC-DC converter of FIG. 3.

Referring to FIG. 3, driving voltage generator 710 includes a digital-to-analog (D/A) converter 720, a storage unit 730, a clock generator 740, and a DC-DC converter 750. An external signal EXT for controlling the driving voltage AVDD is input. Here, a 3-bit digital signal is input in parallel as the external signal EXT. D/A converter 720 converts the external signal EXT into a control voltage signal VCONT having a predetermined voltage in an analog form and provides the control voltage signal VCONT to clock generator 740. The detailed operation of D/A converter 720 will be described later with reference to FIG. 4.

Storage unit 730 stores the external signal EXT. The driving voltage AVDD is controlled by the external signal EXT, and the external signal EXT is stored in storage unit 730 such that the external signal EXT can be provided to D/A converter 720 even when a user does not continuously provide the external signal EXT. Storage unit 730 may be an electrically erasable programmable read-only memory (EEPROM) or an erasable programmable read-only memory (EPROM) in which stored data can be modified according to the external signal EXT.

Clock generator 740 is supplied with the control voltage signal VCONT from D/A converter 720 to generate a clock signal CLK whose duty ratio changes according to the voltage level of the control voltage signal. The detailed operation of clock generator 740 will be described later with reference to FIG. 5.

DC-DC converter 750 converts the level of an input voltage Vin according to the duty ratio of clock signal CLK supplied from clock generator 740 to output the input voltage Vin as the driving voltage AVDD. The detailed operation of the DC-DC converter 750 will be described later with reference to FIG. 6.

Referring to FIG. 4, D/A converter 720 includes a plurality of resistors R1-R8 connected in series to divide the level of a predetermined reference voltage Vref, second switching elements S1-S8 connected to nodes having voltages of different levels, and a decoder 721. The operation of D/A converter 720 will be described for a case where the external signal EXT is a 3-bit digital signal 101. When the digital signal 101 is input to decoder 721, only the second switching element S5 corresponding to the digital signal 101 is turned on by decoder 721. At this time, the reference voltage Vref undergoes a voltage drop through the four resistors R8, R7, R6, and R5 to generate a voltage of a level corresponding to the digital signal 101 and the generated voltage is output as the control voltage signal VCONT through a buffer 722. It will be apparent that D/A converter 720 may be of an R-2R ladder type and the external signal EXT is not limited to a 3-bit signal.

Referring to FIG. 5, clock generator 740 includes an oscillator 742 and a comparator 744 and generates clock signal CLK whose duty ratio changes according to the control voltage signal VCONT. Oscillator 742 generates a reference clock signal RCLK having a constant frequency. Comparator 744 compares the control voltage signal VCONT generated by D/A converter 720 with the reference clock signal RCLK generated by oscillator 742. Thus, comparator 744 outputs a voltage of a predetermined level if the level of the control voltage signal VCONT is higher than that of the reference clock signal RCLK and outputs 0 volts if the level of the control voltage signal VCONT is lower than that of the reference clock signal RCLK, thereby generating clock signal CLK. Since the frequency of the reference clock signal RCLK is constant, the duty ratio of clock signal CLK changes according to the level of the control voltage signal VCONT. However, clock generator 740 may be any type of clock generator that generates a clock signal whose duty ratio changes according to the control voltage signal VCONT.

Referring to FIG. 6, the DC-DC converter 750 is a boost converter and includes an inductor 751 to which the input voltage Vin, i.e., a DC voltage, is applied; a diode 752 whose anode is connected to the inductor 751 and cathode is connected to an output terminal for the driving voltage AVDD; a capacitor 754 connected between the cathode of the diode 752 and a ground to output the driving voltage AVDD; and a third switching element 753 that is connected between the anode of the diode 752 and the ground to be turned on/off according to clock signal CLK.

When the third switching element 753 is turned on according to clock signal CLK, the amount of current I_{L} flowing through the inductor 751 increases in proportion to the input voltage Vin applied across the ends of the inductor 751 and according to the current and voltage characteristics of the inductor 751. As the time during which the third switching element 753 is turned on increases, the amount of current I_{L} flowing through the inductor 751 also increases. A voltage charged into the capacitor 754 is output as the driving voltage AVDD.

When the third switching element 753 is turned off, the current I_{L} flowing through the inductor 751 flows through the diode 752 and a voltage is charged into the capacitor 754 according to the current and voltage characteristics of the capacitor 754. Thus, the input voltage Vin is boosted to a predetermined voltage and is output as the driving voltage AVDD. As such, the amount of current flowing through inductor 751 changes with the duty ratio of clock signal CLK that turns on/off the third switching element 753 and such a change boosts or drops the driving voltage AVDD. However, the DC-DC converter 750 may be any type of converter and is not limited to the foregoing description.

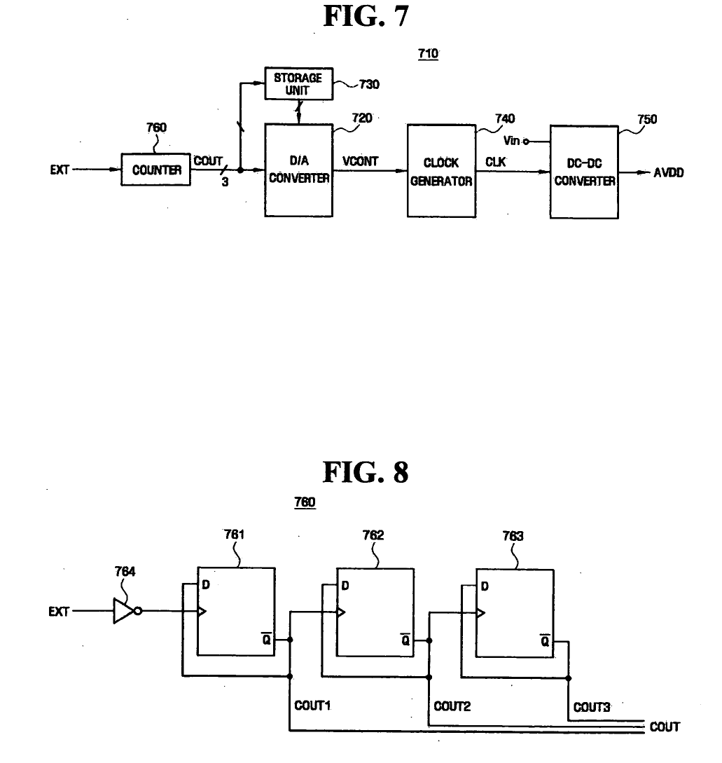

FIG. 7 is a block diagram of a driver according to another embodiment of the present invention, and FIG. 8 is a circuit diagram of the counter of FIG. 7. For sake of clarity and convenience of explanation, components each having the same function for describing the embodiments shown in FIG. 3 are respectively identified by the same reference numerals, and their repetitive description will be omitted.

Referring to FIG. 7, driving voltage generator 710 includes a counter 760, D/A converter 720, storage unit 730, clock generator 740, and DC-DC converter 750. A digital signal is serially input as the external signal EXT for controlling the driving voltage AVDD.

The input external signal EXT passes through counter 760 and is input in parallel to D/A converter 720. D/A converter 720 converts an output signal COUT of the counter 760 into the control voltage signal VCONT in an analog form. Clock generator 740 generates clock signal CLK whose duty ratio changes according to the control voltage signal VCONT. The DC-DC converter 750 converts the level of the input voltage Vin according to the duty ratio of clock signal CLK and outputs a voltage whose level is driving voltage AVDD. Storage unit 730 stores the output signal COUT of the counter 760.

Referring to FIG. 8, the counter 730 is a 3-bit up-counter and includes first through third D flip-flops 761, 762, and 763. When the external signal EXT is serially input to an inverter 764, an output signal COUT1 of the first D flip-flop 761 is toggled at every falling edge of the external signal EXT, an output signal COUT2 of the second D flip-flip 762 is toggled at every falling edge of the output signal COUT1 of the first D flip-flop 761, and an output signal COUT3 of the third D flip-flop 763 is toggled at every falling edge of the output signal COUT2 of the second D flip-flop 762, thereby counting the number of high levels of the external signal EXT. In other words, the number of high levels of the external signal EXT is counted one-by-one from 0 to 7. The output signals COUT1, COUT2, and COUT3 of the first through third D flip-flops 761, 762, and 763 are input in parallel to D/A converter 720. Counter 760 may be implemented in various ways and is not limited to the foregoing description. For example, the counter 760 may be a down-counter that decrements by 1 for each high level of the external signal EXT, or an up/down counter that increments or decrements according to a high level or a low level when the external signal EXT is a pulse having a high level or a low level with respect to a predetermined voltage. Counter 760 may also be a serial-to-parallel converter which converts the serially input external signal EXT to the parallel external signal EXT.

Driver 710 according to embodiments of the present invention supplies the driving voltage AVDD to the common voltage generator 780 and the common voltage generator 780 divides the driving voltage AVDD using its resistors to generate the common voltage Vcom. Thus, even when the common voltage Vcom changes, the common voltage Vcom is controlled using the external signal EXT, thereby correcting a distorted image signal. In addition, when gate-on/off voltages Von and Voff change, they can be controlled using the external signal EXT.

As described above, according to the present invention, a distorted image signal can be corrected. While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

What is claimed is:

1. A driver of a display device, the driver comprising:
a control voltage signal generator which converts the voltage level of a control voltage signal according to an external signal;
a clock signal generator which generates a clock signal whose duty ratio changes according to the voltage level of the control voltage signal; and
a DC-DC converter which converts the level of an input voltage according to the duty ratio of the clock signal supplied from the clock signal generator and outputs the input voltage whose level is converted as a driving voltage.

2. The driver of claim 1, wherein the control voltage signal generator comprises a digital-to-analog (D/A) converter which converts the external signal into the control voltage signal, and the control voltage signal output from the D/A is in an analog form.

3. The driver of claim 2, wherein the control voltage signal generator further comprises a storage unit which stores the external signal.

4. The driver of claim 3, wherein the storage unit is an electrically erasable programmable read-only memory (EEPROM).

5. The driver of claim 1, wherein the control voltage signal generator comprises:
a counter which counts the number of high levels and/or low levels of the external signal; and
a digital-to-analog (D/A) converter which converts an output signal of the counter into the control voltage signal, and the control voltage signal output from the D/A is in an analog form.

6. The driver of claim 5, wherein the control voltage signal generator further comprises a storage unit which stores the output signal of the counter.

7. The driver of claim 6, wherein the storage unit is an electrically erasable programmable read-only memory (EEPROM).

8. The driver of claim 1, wherein the DC-DC converter is a boost converter which boosts the level of the input voltage.

9. The driver of claim 8, wherein the clock signal generator comprises:
an oscillator which outputs a reference clock signal having a constant frequency; and
a comparator which compares the control voltage signal with the reference clock signal and outputs the clock signal.

10. A display device comprising:
a control voltage signal generator which converts the voltage level of a control voltage signal according to an external signal;
a clock signal generator which generates a clock signal whose duty ratio changes according to the voltage level of the control voltage signal;
a DC-DC converter which converts the level of an input voltage according to the duty ratio of the clock signal supplied from the clock signal generator and outputs the input voltage whose level is converted as a driving voltage; and
a gray voltage generator which converts the level of the driving voltage and generates a gray voltage.

11. The display device of claim 10, wherein the control voltage signal generator comprises a digital-to-analog (D/A) converter which converts the external signal into the control voltage signal, and the control voltage signal output from the D/A is in an analog form.

12. The display device of claim 11, wherein the control voltage signal generator further comprises a storage unit which stores the external signal.

13. The display device of claim 12, wherein the storage unit is an electrically erasable programmable read-only memory (EEPROM).

14. The display device of claim 10, wherein the gray voltage generator comprises a plurality of resistors that are connected in series between a node to which the driving voltage is applied and a ground and the resistors divide the level of the driving voltage to generate the gray voltage.

15. The display device of claim 10, wherein the control voltage signal generator comprises:
a counter which counts the number of high levels and/or low levels of the external signal; and
a digital-to-analog (D/A) converter which converts an output signal of the counter into the control voltage signal, and the control voltage signal output from the D/A is in an analog form.

16. The display device of claim 15, wherein the control voltage signal generator further comprises a storage unit which stores the output signal of the counter.

17. The display device of claim 16, wherein the storage unit is an electrically erasable programmable read-only memory (EEPROM).

18. The display device of claim 10, wherein the DC-DC converter is a boost converter which boosts the level of the input voltage.

19. The display device of claim 18, wherein the clock signal generator comprises:
an oscillator which outputs a reference clock signal having a constant frequency; and
a comparator which compares the control voltage signal with the reference clock signal and outputs the clock signal.

20. A display device comprising:
a digital-to-analog (D/A) converter which converts an external signal into a control voltage signal in an analog form;
an oscillator which outputs a reference clock signal having a constant frequency;
a comparator which compares the control voltage signal with the reference clock signal and based on the comparison outputs a clock signal whose duty ratio changes according to the voltage level of the control voltage signal; and
a boost converter which converts the voltage level of an input voltage in response to the clock signal and outputs the input voltage whose level is converted as a driving voltage.

21. The display device of claim 20, wherein the display device further comprises an electrically erasable programmable read-only memory (EEPROM) which stores the external signal.

22. A display device comprising:
a counter which counts the number of high levels and/or low levels of an external signal;
a digital-to-analog (D/A) converter which converts an output signal of the counter into a control voltage signal, and the control voltage signal output from the D/A is in an analog form;
an oscillator which outputs a reference clock signal having a constant frequency;
a comparator which compares the control voltage signal with the reference clock signal and based on the comparison outputs a clock signal whose duty ratio changes according to the voltage level of the control voltage signal; and
a boost converter which converts the voltage level of an input voltage in response to the clock signal and outputs the input voltage whose level is converted as a driving voltage.

23. The display device of claim 22, wherein the display device further comprises an electrically erasable programmable read-only memory (EEPROM) which stores the output signal of the counter.
